(19) United States
(12) Patent Application Publication
(10) Pub. No.: US 2025/0329995 A1
(43) Pub. Date: Oct. 23, 2025

(54) SWITCHGEAR ASSEMBLY WITH ADJUSTABLE FRAME

(71) Applicant: G & W Electric Company, Bolingbrook, IL (US)

(72) Inventors: Nathan S. Zwartz, Frankfort, IL (US); Erick James C. Calma, Westmont, IL (US)

(21) Appl. No.: 18/641,073

(22) Filed: Apr. 19, 2024

(51) Int. Cl. H02B 1/01

(52) U.S. Cl. CPC H02B 1/011; H02B 1/012

(57) ABSTRACT

A switchgear assembly includes a switchgear and a frame configured to support the switchgear, the frame including, a base frame section connected to a base surface, a slidable frame section slidably coupled to the base frame section and movable to vary a height of the switchgear relative to the base surface, and a tiltable frame section pivotably coupled to the slidable frame section and movable to vary a tilt angle of the switchgear relative to the base surface.

### FIELD OF THE DISCLOSURE

The present disclosure relates to switchgear, and, more particularly, to an adjustable frame for supporting switchgear.

### BACKGROUND OF THE DISCLOSURE

Switchgear is often installed in underground electrical vaults, on concrete pads, and other like locations with limited surrounding space. Switchgear is also typically heavy and difficult to position, requiring the use of lifts or cranes. Switchgear may be supported on an adjustable frame to position the switchgear in a desired orientation. However, typical adjustable frames may provide only height adjustment, or only angle adjustment. Typical adjustable frames may also require that the switchgear be removed from the frame to adjust the height of the frame or the angle of the frame. This makes installation more difficult and time consuming.

### SUMMARY OF THE DISCLOSURE

In some aspects, the techniques described herein relate to a switchgear assembly including: a switchgear; and a frame configured to support the switchgear, the frame including, a base frame section connected to a base surface, a slidable frame section slidably coupled to the base frame section and movable to vary a height of the switchgear relative to the base surface, and a tiltable frame section pivotably coupled to the slidable frame section and movable to vary a tilt angle of the switchgear relative to the base surface.

In some aspects, the techniques described herein relate to a switchgear assembly, wherein the switchgear is coupled to and supported by the tiltable frame section.

In some aspects, the techniques described herein relate to a switchgear assembly, wherein the base frame section is movable to vary the height of the switchgear and the tiltable frame section is movable to vary the tilt angle of the switchgear while the switchgear is coupled to and supported by the tiltable frame section.

In some aspects, the techniques described herein relate to a switchgear assembly, wherein the base frame section includes a C-shaped channel, and wherein the slidable frame section includes a C-shaped channel slidably received by the C-shaped channel of the base frame section.

In some aspects, the techniques described herein relate to a switchgear assembly, wherein the slidable frame section includes a tilt-locking bracket, and wherein the tilt-locking bracket includes a plurality of tilt holes, each corresponding with a different tilt angle of the switchgear relative to the base surface.

In some aspects, the techniques described herein relate to a switchgear assembly, further including a fastener insertable through a selected one of the plurality of tilt holes to prevent the tiltable frame section from pivoting.

In some aspects, the techniques described herein relate to a switchgear assembly, wherein the tiltable frame section is pivotable about a pivot axis at least partially formed by the tiltable frame section and the slidable frame section, and wherein the tilt holes are spaced apart from one another at a constant radius from the pivot axis.

In some aspects, the techniques described herein relate to a switchgear assembly, wherein the slidable frame section includes a backstop configured to prevent the tiltable frame section from pivoting beyond the backstop.

In some aspects, the techniques described herein relate to a frame for use with a switchgear, the frame including: a base frame section connected to a base surface; a slidable frame section slidably coupled to the base frame section and movable relative to the base frame section between a raised position and a lowered position; and a tiltable frame section pivotally coupled to the slidable frame section and pivotable about a pivot axis relative to the slidable frame section between a vertical position and a tilted position, wherein the tiltable frame section is configured to support the switchgear.

In some aspects, the techniques described herein relate to a frame, wherein the base frame section includes first and second channels, and wherein the slidable frame section includes first and second channels slidably received by the first and second channels of the base frame section.

In some aspects, the techniques described herein relate to a frame, wherein each of the first and second channels of the slidable frame section includes a slot.

In some aspects, the techniques described herein relate to a frame, wherein the slidable frame section includes a first and second tilt-locking brackets, and wherein each of the first and second tilt-locking brackets includes a plurality of tilt holes, each corresponding with a different tilt angle of the tiltable frame section relative to the slidable frame section.

In some aspects, the techniques described herein relate to a frame, wherein the tilt holes are spaced apart from one another at a constant radius from the pivot axis.

In some aspects, the techniques described herein relate to a frame, wherein the slidable frame section includes a backstop configured to prevent the tiltable frame section from pivoting beyond the backstop.

In some aspects, the techniques described herein relate to a frame, wherein the tiltable frame section includes a hoist bracket configured to connect to a hoist.

In some aspects, the techniques described herein relate to a method of adjusting a position of a switchgear supported by a frame assembly including a base frame section, a slidable frame section, and a tiltable frame section, the method including: coupling the base frame section to a base surface; sliding the slidable frame section relative to the base surface to adjust a height of the switchgear; locking the slidable frame section to the base frame section; pivoting the tiltable frame section relative to the slidable frame section about a pivot axis to adjust a tilt angle of the switchgear; and locking the tiltable frame section to the slidable frame section.

In some aspects, the techniques described herein relate to a method, wherein locking the tiltable frame section to the slidable frame section includes aligning an aperture in the tiltable frame section with one of a plurality of apertures in the slidable frame section, and, inserting a fastener through the aligned apertures.

In some aspects, the techniques described herein relate to a method, wherein locking the slidable frame section to the base frame section includes aligning an aperture in the slidable frame section with one of a plurality of apertures in the base frame section, and, inserting a fastener through the aligned apertures.

In some aspects, the techniques described herein relate to a method, wherein sliding the slidable frame section and pivoting the tiltable frame section are performed while the switchgear is supported by the frame assembly.

In some aspects, the techniques described herein relate to a method, wherein the method further includes adjusting one or more fasteners of the frame prior to sliding the slidable frame section and pivoting the tiltable frame section.

Other aspects of the disclosure will become apparent by consideration of the detailed description and accompanying drawings.

### BRIEF DESCRIPTION OF THE DRAWINGS

FIG. 1 is a perspective view of a switchgear assembly including switchgear coupled to a frame according to an embodiment of the present disclosure.

FIG. 2 is a perspective view of the switchgear assembly of FIG. 1 in a raised and tilted position.

FIG. 3 is a front perspective view of a base frame section of the switchgear assembly of FIG. 1.

FIG. 4 is a rear perspective view of the base frame section of FIG. 3.

FIG. 5 is a front perspective view of a slidable frame section of the switchgear assembly of FIG. 1.

FIG. 6 is a rear perspective view of the slidable frame section of FIG. 5.

FIG. 7 is an enlarged perspective view of the switchgear assembly of FIG. 1 showing a connection between the base frame section and the slidable frame section.

FIG. 8 is an enlarged top view of the connection of FIG. 7.

FIG. 9 is an enlarged perspective view of the switchgear assembly of FIG. 1 showing a slot of the slidable frame section with the slidable frame section in a lowered position.

FIG. 10 is an enlarged perspective view of the slot of the base frame section of FIG. 9 with the slidable frame section in a raised position.

FIG. 11 is a perspective view of the frame of the switchgear assembly of FIG. 1 in a compact configuration, with the slidable frame section in the lowered position and a tiltable frame section in an untilted position.

FIG. 12 is a perspective view of the frame of FIG. 11 with the slidable frame section in a raised position.

FIG. 13 is a side view of the frame of FIG. 12.

FIG. 14 is a perspective view of a frame according to another embodiment of the present disclosure.

FIG. 15 is a side view of the frame of FIG. 14.

FIG. 16 is a front perspective view of the frame of FIG. 12 showing a tiltable frame section.

FIG. 17 is a back perspective view of the tiltable frame section of FIG. 16.

FIG. 18 is a front perspective view of the frame of FIG. 12 in a tilted position.

FIG. 19 is a side view of the frame of FIG. 18 in the tilted position.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting. In addition, as used herein and in the appended claims, the terms “upper”, “lower”, “top”, “bottom”, “front”, “back”, and other directional terms are not intended to require any particular orientation but are instead used for purposes of description only.

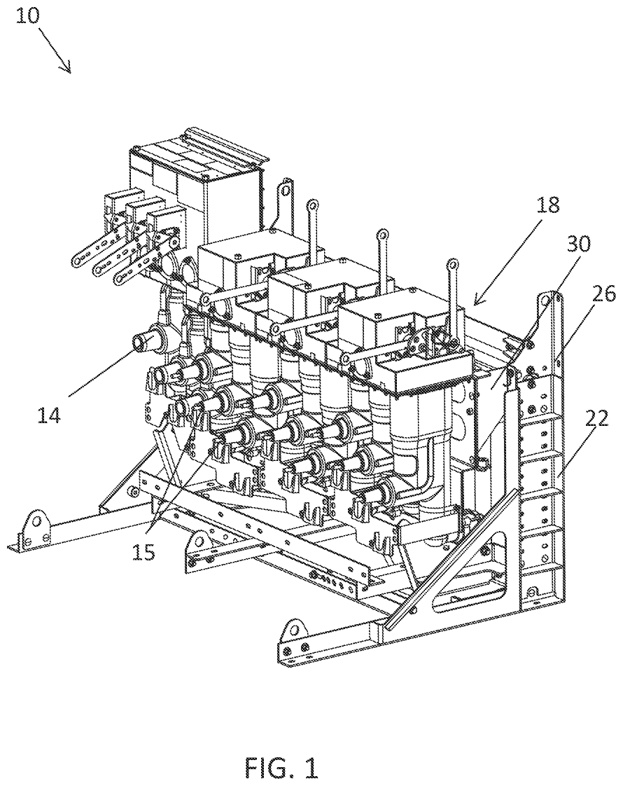

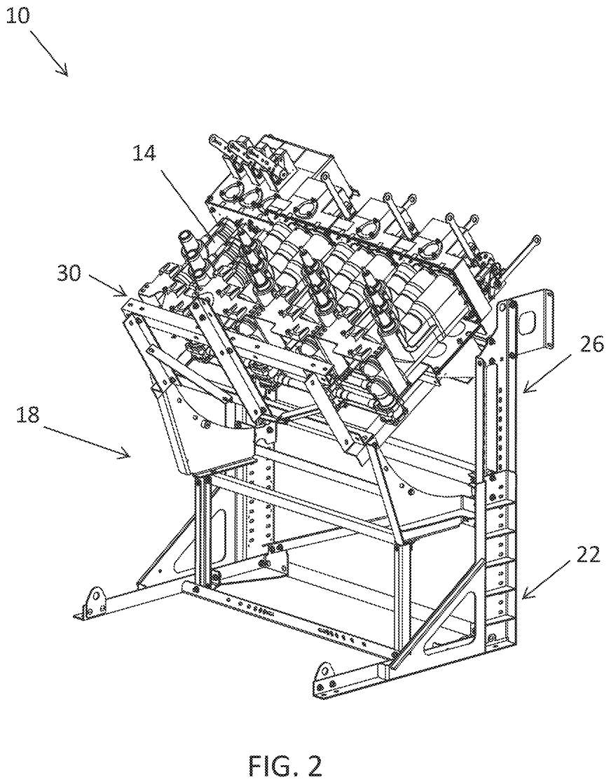

FIGS. 1-2 illustrates a switchgear assembly 10 including an exemplary switchgear 14 coupled to a frame or frame assembly 18 according to an embodiment of the present disclosure. The illustrated frame 18 includes a base frame section 22, a slidable frame section 26 slidably coupled to the base frame section 22, and a tiltable frame section 30 pivotably coupled to the slidable frame section 26. The switchgear 14 may include one or more reclosers, interrupters, disconnect switches, operating mechanisms, interlocks, and/or other such components arranged in any desired single or multi-way configuration. The switchgear 14 includes one or more electrical connections 15 (e.g., bushings) configured for connection to a power source or load via suitable conductors, such as cables, busbars, and the like. The switchgear 14 may be coupled to the tiltable frame section 30 via fasteners or in any manner suitable for supporting the weight of the switchgear 14. The frame 18 may be positioned within and secured to the floor of an electrical vault in some embodiments or secured to a concrete pad or any other desired surface (e.g., via fasteners or any other suitable arrangement). As described in greater detail below, the slidable frame section 26 is movable relative to the base frame section 22 to adjust a height of the switchgear 14 relative to the base frame section 22. The tiltable frame section 30 is pivotable to adjust a tilt orientation of the switchgear 14 relative to the base frame section 22 (and thus, relative to a support surface to which the base frame section 22 may be coupled). Thus, the frame 18 allows for adjusting both the height and tilt angle of the switchgear 14 while the switchgear 14 remains attached to the frame 18, thereby facilitating efficient installation of the switchgear assembly 10 in a desired position and location.

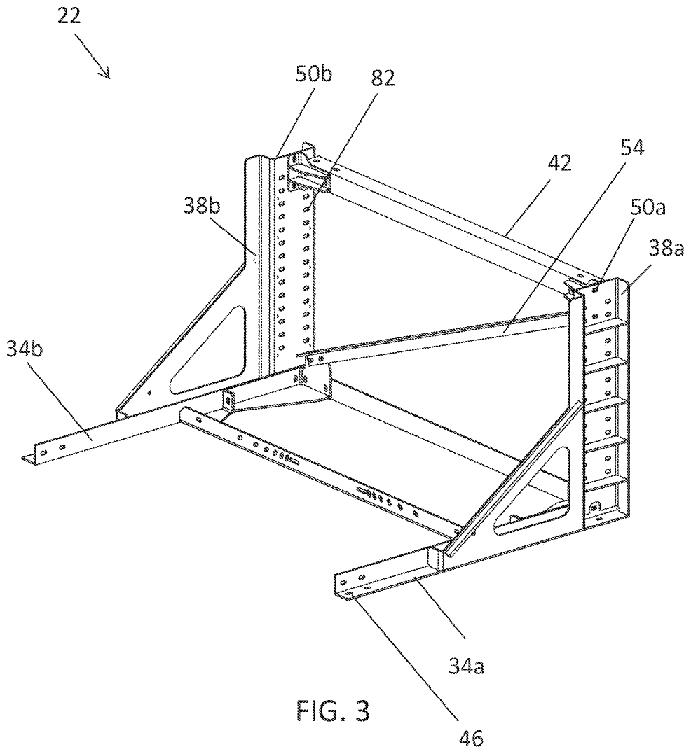

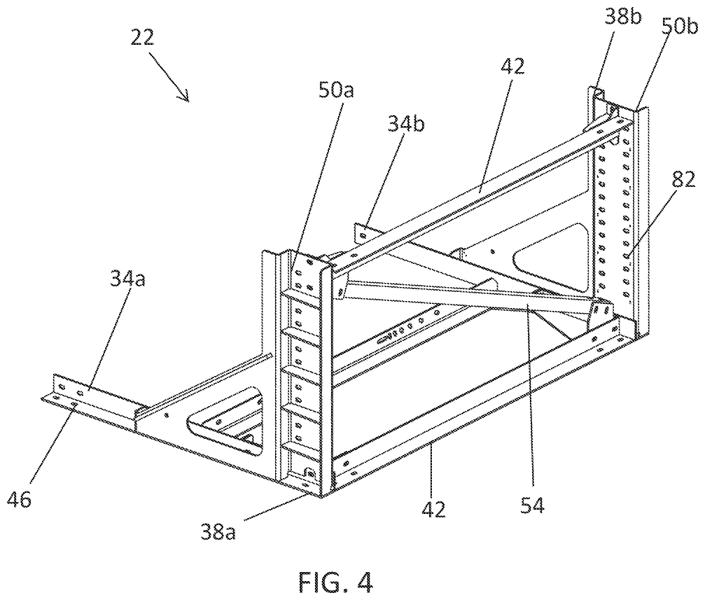

With reference to FIGS. 3-4, the base frame section 22 of the frame 18 includes first and second base beams 34a, 34b coupled to first and second side beams 38a, 38b. The first base beam 34a is coupled to the first side beam 38a, and the second base beam 34b is coupled to the second side beam 38b. The first base beam 34a and the first side beam 38a define a first side of the frame 18. The second base beam 34b and the second side beam 38b define a second side of the frame 18 opposite to the first side. The first base beam 34a and the first side beam 38a are coupled to the second base beam 34b and the second side beam 38b via one or more cross beams 42. In some embodiments, the first and second sides of the frame 18 are substantially symmetric relative to each other. For example, each component associated with the second side of the frame 18 has a mirrored geometry compared to a respective one of the components associated with the first side of the frame 18.

The first and second base beams 34a, 34b each have an L-shaped cross-section in the illustrated embodiment. In other embodiments, the first and second base beams 34a, 34b may define an alternative shape (e.g., a square-shaped beam, c-shaped beam, or the like). In further embodiments, the first base beam 34a may define a shape that is different than a shape defined by the second base beam 34b. The first and second base beams 34a, 34b each include base apertures 46, which may receive fasteners (not shown) to couple the base frame section 22 to the support surface, such as the floor of the electrical vault, a concrete pad, etc.

With continued reference to FIGS. 3-4, the first side beam 38a has a C-shaped cross-section defining a first C-shaped channel 50a, and the second side beam 38b has a C-shaped cross-section defining a second C-shaped channel 50b. The first and second C-shaped channels 50a, 50b face away from each other. In other words, the first and second C-shaped channels 50a, 50b face away from an interior portion of the frame 18. The first and second C-shaped channels 50a, 50b are configured to receive portions of the slidable frame section 26, as explained in greater detail below.

The first base beam 34a and the first side beam 38a are coupled via fasteners that extend through apertures disposed in the first base beam 34a and the first side beam 38a. The first base beam 34a and the first side beam 38a are further coupled via a support bracket. In other embodiments, the first base beam 34a and the first side beam 38a may be coupled with alternative connectors. Similarly, the second base beam 34b and the second side beam 38b are coupled via fasteners that extend through apertures disposed in the second base beam 34b and the second side beam 38b. The second base beam 34b and the second side beam 38b are further coupled via a support bracket. The first and second base beams 34a, 34b are perpendicular to the first and second side beams 38a, 38b in the illustrated embodiment, but may be oriented differently in other embodiments.

With continued reference to FIGS. 3-4, the first base beam 34a and the first side beam 38a are coupled to the second base beam 34b and the second side beam 38b by a plurality of cross beams 42, 54. The illustrated cross beams includes horizontal cross beams 42 extending perpendicular to the side beams 38a, 38b, and an angled cross beam 54 extending at an oblique angle between the side beams 38a, 38b. In other embodiments, the number or arrangement of cross beams 42, 54 may vary. The cross beams 42, 54 have L-shaped cross-sections in the illustrated embodiment but may have other shapes (e.g., a square-shaped, c-shaped, or the like).

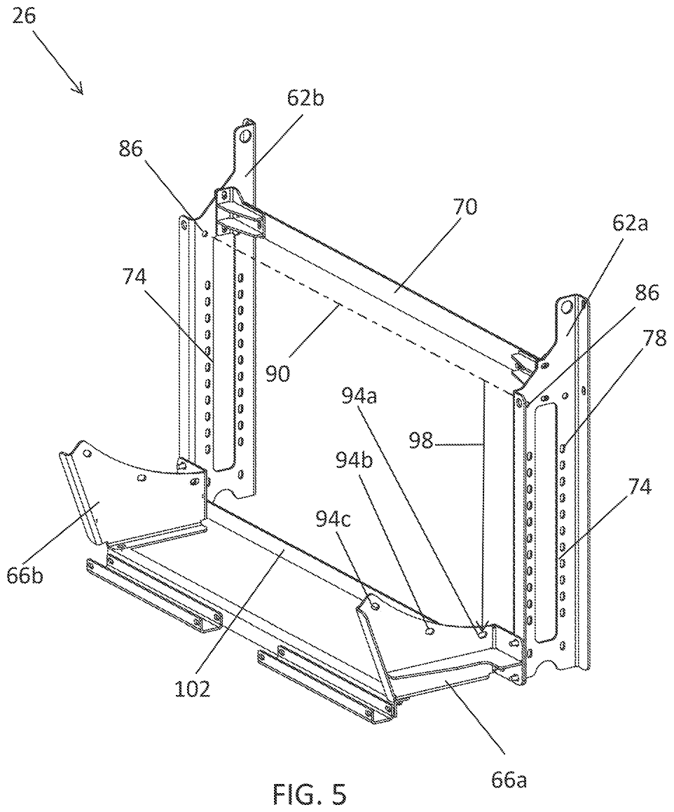

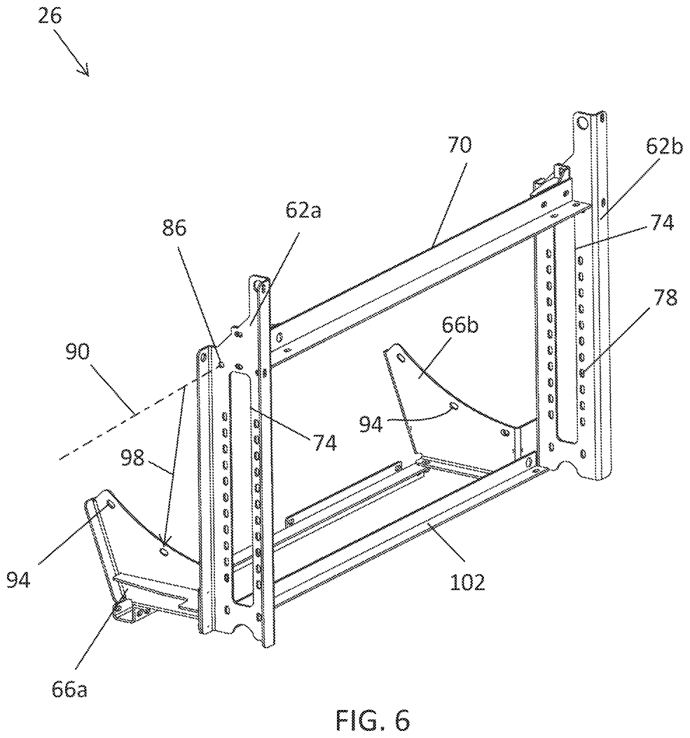

With reference to FIGS. 5-6, the slidable frame section 26 is slidably coupled to the base frame section 22. The slidable frame section 26 includes first and second C-shaped channels 62a, 62b and first and second tilt-locking brackets 66a, 66b. The first C-shaped channel 62a is coupled to the first tilt-locking bracket 66a, for example, via one or more fasteners and/or fastening methods or techniques (e.g., welding). The first C-shaped channel 62a and the first tilt locking bracket 66a are positioned on the first side of the frame 18. The second C-shaped channel 62b is coupled to the second tilt-locking bracket 66b (e.g., via fasteners). The second C-shaped channel 62b and the second tilt-locking bracket 66b are positioned on the second side of the frame 18. The first C-shaped channel 62a and the first tilt-locking bracket 66a are coupled to the second C-shaped channel 62b and the second tilt-locking bracket 66b via cross beams 70, as explained below.

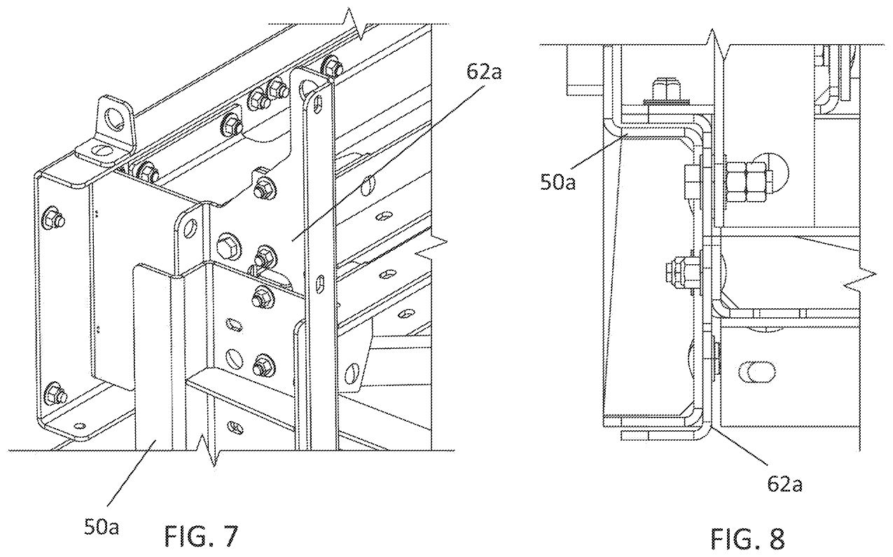

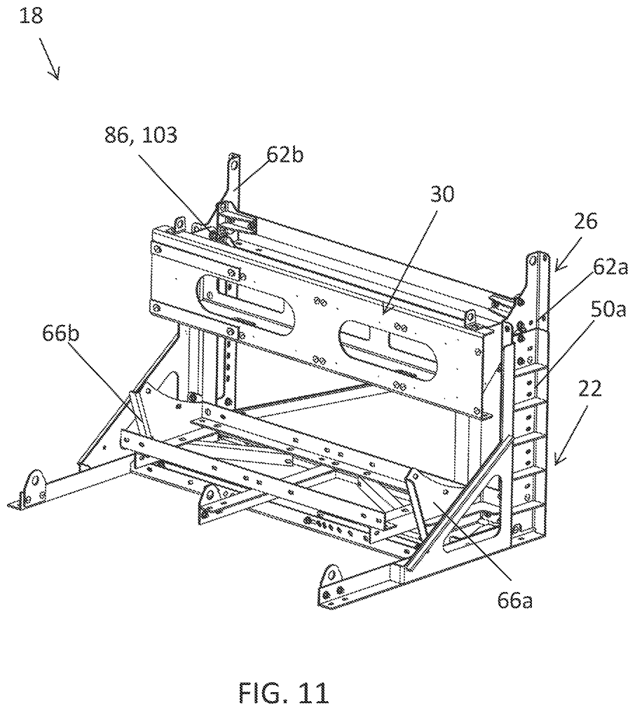

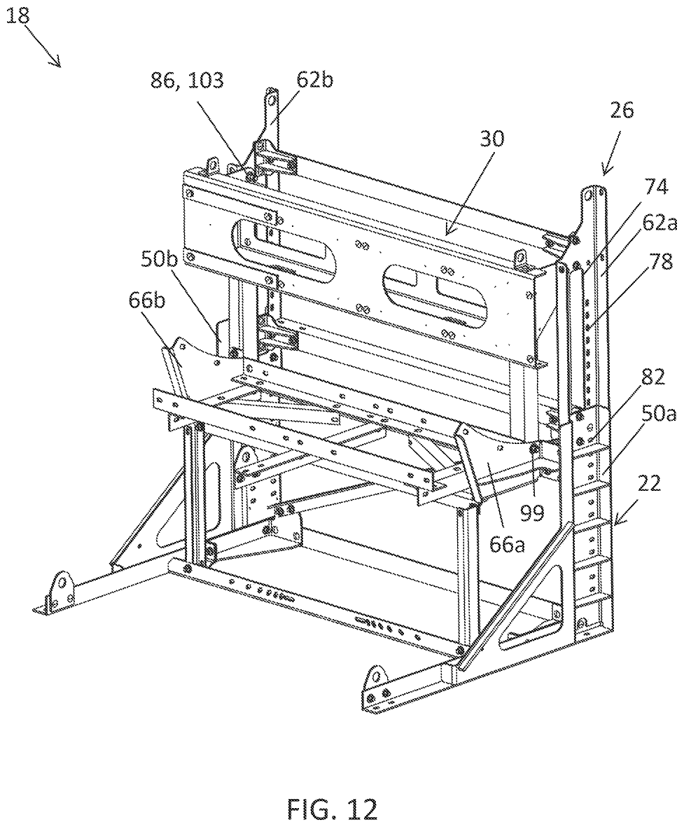

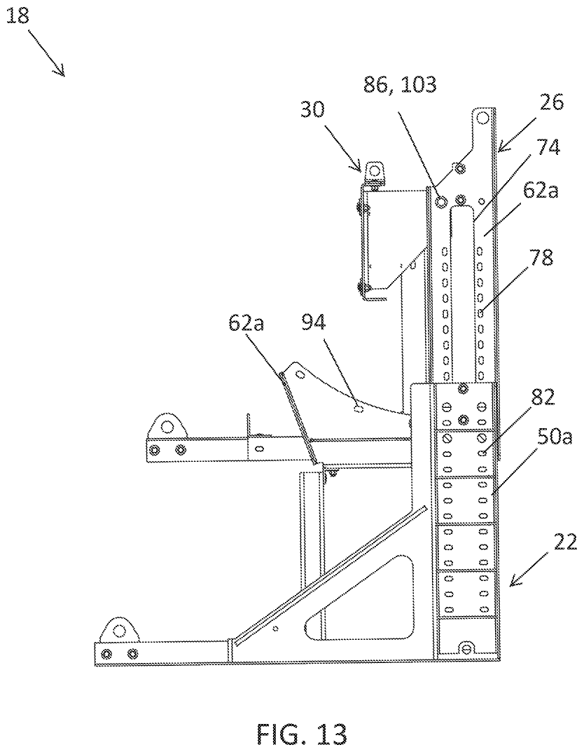

With reference to FIGS. 7-8, the first and second C-shaped channels 62a, 62b of the slidable frame section 26 matingly engage with inner surfaces of the first and second C-shaped channels 50a, 50b of the base frame section 22. More specifically, the first C-shaped channel 50a of the base frame section 22 receives the first C-shaped channel 62a of the slidable frame section 26, and the second C-shaped channel 50b of the base frame section 22 receives the second C-shaped channel 62b of the slidable frame section 26. Because the first and second C-shaped channels 62a, 62b of the slidable frame section 26 engage with inner surfaces of the first and second C-shaped channels 50a, 50b, of the base frame section 22, the first and second C-shaped channels 62a, 62b of the slidable frame section 26 are thus disposed between the first and second C-shaped channels 50a, 50b of the base frame section 22. The C-shaped channels 62a, 62b of the slidable frame section 26 are slidable along the C-shaped channels 50a, 50b of the base frame section 22, which allows the slidable frame section 26 to move between raised (FIG. 12) and lowered (FIG. 11) positions relative to the base frame section 22.

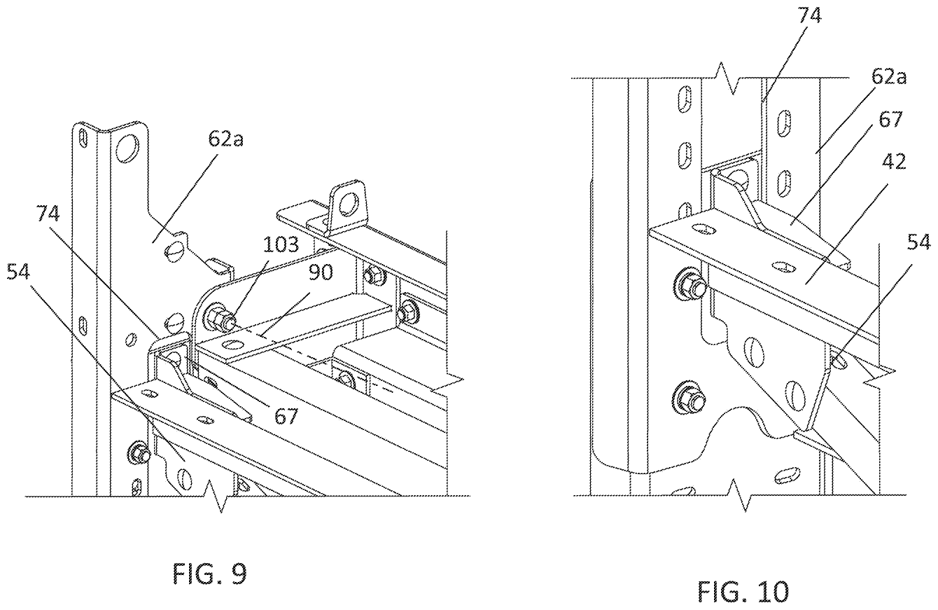

Referring to FIGS. 5-6, in the illustrated embodiment, each of the first and second C-shaped channels 62a, 62b of the slidable frame section 26 includes a slot (e.g., a relatively long slot) 74. In some embodiments, each slot 74 extends substantially from one end of the respective C-shaped channel to an opposite end thereof. As best illustrated in FIGS. 9 and 10, a secondary joint (e.g., a fixed, structural joint) 67 coupling the cross beams 42, 54 to the part of the base frame section 22 that extends through the slots 74. In some embodiments, the secondary joint 67 of the frame 18 is implemented using a bracket such as, for example, a bracket constructed of sheet metal having one or more bends, flanges, and/or welds thereon. Engagement between the secondary joint 67 and the ends of the associated slot 74 may thus limit movement of the slidable frame section 26 between a lowered position, as shown in FIG. 11, and a raised position, as shown in FIG. 12. In some embodiments, the raised position may be below the lowered position. For example, the slidable frame section 26 may be configured to lower the switchgear 14 into an electrical vault. Thus, the raised position may also be referred to as an extended position. In some such embodiments, when the frame 18 is in the extended position, one or more (e.g., all) of the electrical connection(s) 15 of the switchgear 14 are positioned at or below ground level while at least part of the frame 18 remains at or above the ground level.

With reference to FIG. 12, the first and second C-shaped channels 62a, 62b of the illustrated slidable frame section 26 additionally include apertures 78 spaced along the height direction and configured to receive fasteners. The first and second C-shaped channels 50a, 50b of the base frame section 22 include corresponding apertures 82. In some embodiments, spacing between adjacent apertures 78 of the slidable frame section 26 is substantially the same compared to spacing between adjacent apertures 82 of the base frame section 22. Further, the aperture spacing may include a relatively small distance (e.g., about 2 inches or less) defined between the adjacent apertures. When the fastener is inserted through a corresponding pair of the apertures 78, 82, the fastener holds in place the slidable frame section 26 relative to the base frame section 22. Therefore, after the height position of the slidable frame section 26 is adjusted relative to the base frame section 22, the fasteners lock the slidable frame section 26 at a desired height relative to the base frame section 22.

For example, in use, before and/or after the base frame section 22 is secured to a concrete pad, within an electrical vault, or in a desired location, the slidable frame section 26 can be adjusted (i.e., moved between the lowered position and the raised position) via heavy lifting equipment, such as a forklift or hoist (e.g., a crane, chain hoist, hydraulic lifter, or other suitable lifting arrangement). Once the height of the slidable frame section 26 is at a desired height, a user inserts the fasteners through the apertures 82, 78. While the fasteners are in place, the slidable frame section 26 remains at the desired height. In other words, when the fasteners are in place, the slidable frame section 26 is locked in place at the desired height.

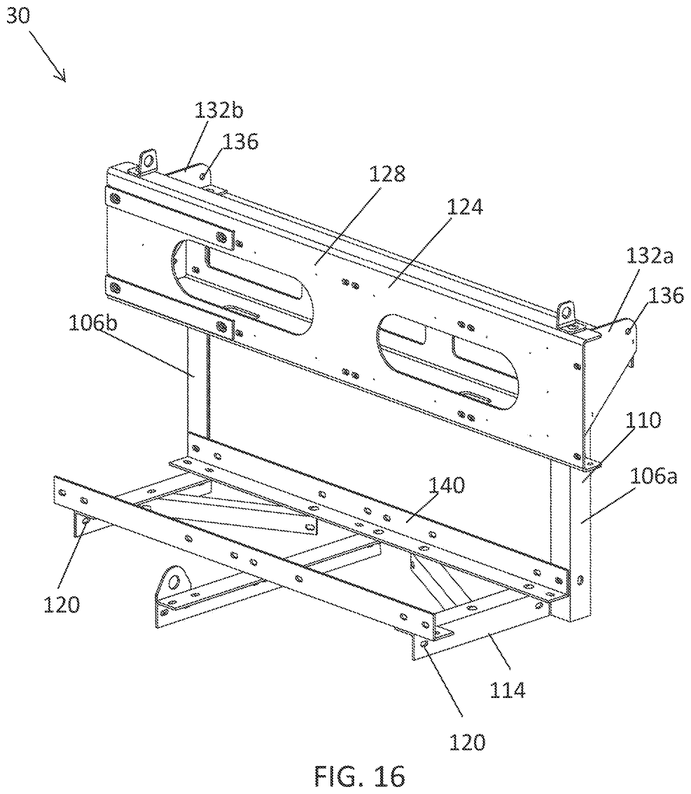

With reference again to FIGS. 5-6, the frame 18 is provided with at least one primary joint (e.g., a pivotable joint) at least partially formed and/or defined by the slidable and tiltable frame sections 26, 30, which facilitates tilting functionality of the frame 18. In some embodiments, as shown in FIGS. 5-6, the first and second C-shaped channels 62a, 62b of the slidable frame section 26 include pivot apertures 86. The pivot apertures 86 are disposed proximate the upper ends of the slots 74 in the first and second C-shaped channels 62a, 62b. The tiltable frame section 30 includes first and second side brackets 132a, 132b disposed on opposite sides of the tiltable frame section 30, each having a pivot aperture 136 (FIG. 16). Fasteners 103, which may be referred to as pivot fasteners 103 or pins (see e.g., FIG. 9), extend through the pivot apertures 136, 86 to couple the tiltable frame section 30 to the slidable frame section 26 for pivoting movement about a pivot axis 90, as described in more detail below.

Referring to FIG. 5-6, the illustrated first and second tilt-locking brackets 66a, 66b are coupled to front surfaces of the first and second C-shaped channels 62a, 62b at lower ends of the C-shaped channels 62a, 62b. Each of the illustrated tilt-locking brackets 66a, 66b includes tilt holes 94a, 94b, 94c (which may also be referred to more generally as tilt holes 94), each positioned at a constant radius 98 from the pivot axis 90. The illustrated brackets 66a, 66b include three tilt holes 94 separated by equal angular spacings. For example, the first tilt hole 94a may be offset fifteen degrees from the second tilt hole 94b, which may be offset fifteen degrees from the third tilt hole 94c. In other embodiments, the tilt holes 94a, 94b, 94c may be spaced separated by different angular spacings (e.g., 20 degrees, 30 degrees, etc.) that is constant among adjacent pairs of tilt holes or varies.

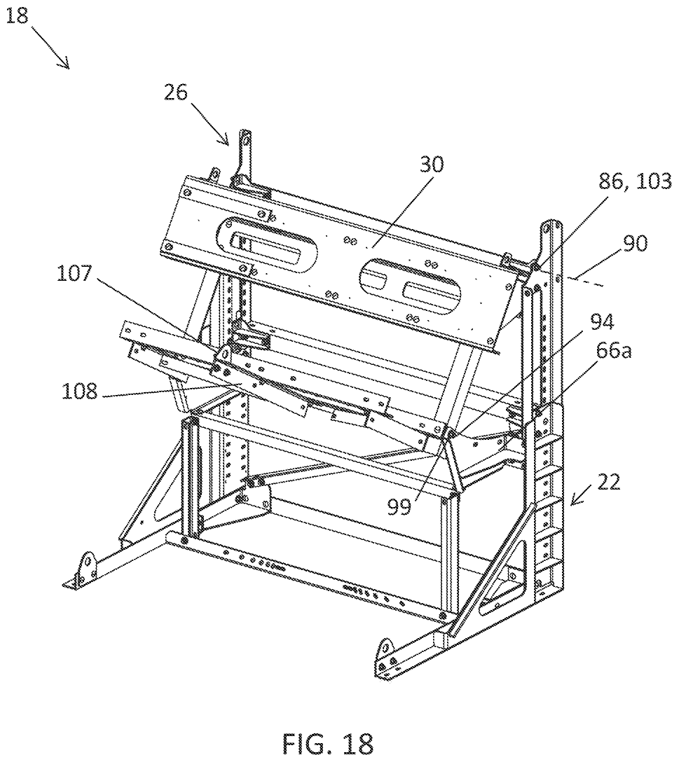

As described in greater detail below, during use, tilt-lock fasteners 99 (FIG. 12) are insertable through selected tilt holes 94a, 94b, 94c and coupled to the tiltable frame section 30 to fix the tiltable frame section 30 in a desired orientation relative to the slidable frame section 26. For example, the tiltable frame section 30 may be fixed in a first orientation (e.g., a vertical orientation) by inserting the tilt-lock fasteners 99 through the first tilt holes 94a, as shown in FIG. 12. The tiltable frame section 30 may also be fixed in a second orientation (e.g., angled 15 degrees relative to the vertical orientation) by inserting the tilt-lock fasteners 99 through the second tilt holes 94b, and in a third orientation (e.g., angled 30 degrees relative to the vertical orientation, as shown in FIG. 18) by inserting the tilt-lock fasteners 99 through the third tilt holes 94c. The tiltable frame section 30 is advantageously adjustable between the various positions via the hoist while the switchgear 14 remains attached to the tiltable frame section.

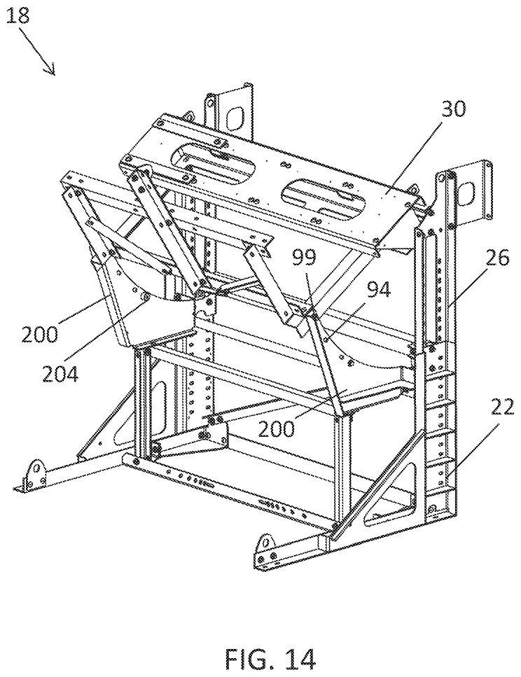

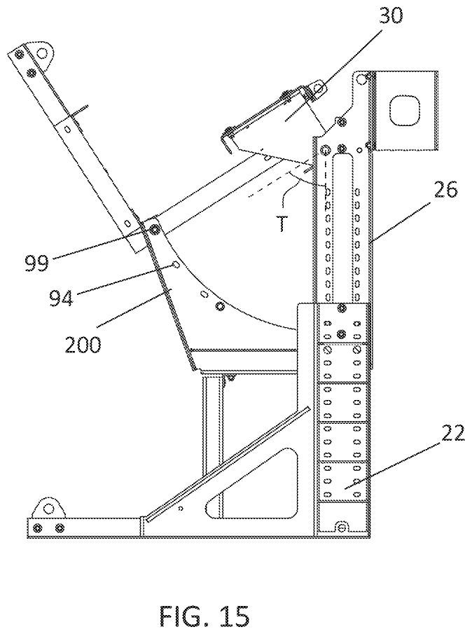

With reference to FIGS. 14-15, in some embodiments, the tilt-locking brackets 66a, 66b may be replaced with extended tilt-locking brackets 200 that further increase an available angle for the tiltable frame section 30 to be held. For example, the extended tilt-locking brackets 200 include tilt holes 94 positioned to permit the tiltable frame section 30 to be oriented at a greater tilt angle T, which may be 45 degrees or more relative to the vertical orientation in some embodiments (e.g., 50 degrees, 60 degrees, 65 degrees, etc.), as shown in FIG. 15. In such embodiments, the extended tilt-locking brackets 200 may include a backstop feature in the form of stoppers 204 (FIG. 14). The stoppers 204 may prevent the tiltable frame section 30 from swinging from the increased angle to a resting position. Rather, the backstop feature 204 stops the tiltable frame section 30 at an intermediate angle (e.g., 15 degrees). The stopper fasteners 204 extend into a path of travel of the tiltable frame section 30. Therefore, the stopper fasteners 204 inhibit further rotation of the tiltable frame section 30 when the tiltable frame section 30 is at the intermediate angle. In other embodiments, the backstop feature 204 may include other structures, such as a beam, a pole, or the like.

Returning to FIGS. 5-6, the first tilt-locking bracket 66a and the first C-shaped channel 62a are coupled to the second tilt-locking bracket 66b and the second C-shaped channel 62b via the cross beams 70. The cross beams 70 are each L-shaped beams in the illustrated embodiment but may have other shapes. The illustrated slidable frame section 26 further includes a backstop beam 102 extending from the first tilt-locking bracket 66a to the second tilt-locking bracket 66b. The backstop beam 102 is positioned adjacent a back of the first and second tilt-locking brackets 66a, 66b. The illustrated backstop beam 102 is an L-shaped beam but may have other shapes. The backstop beam 102 is configured to prevent the tiltable frame section 30 from rotating beyond the backstop beam 102. In other embodiments, the backstop beam 102 may be replaced with an alternative backstop feature. For example, the backstop feature may be bolts extending inward from the tilt-locking brackets. In yet other embodiments, the slidable frame section 26 may not include a backstop feature.

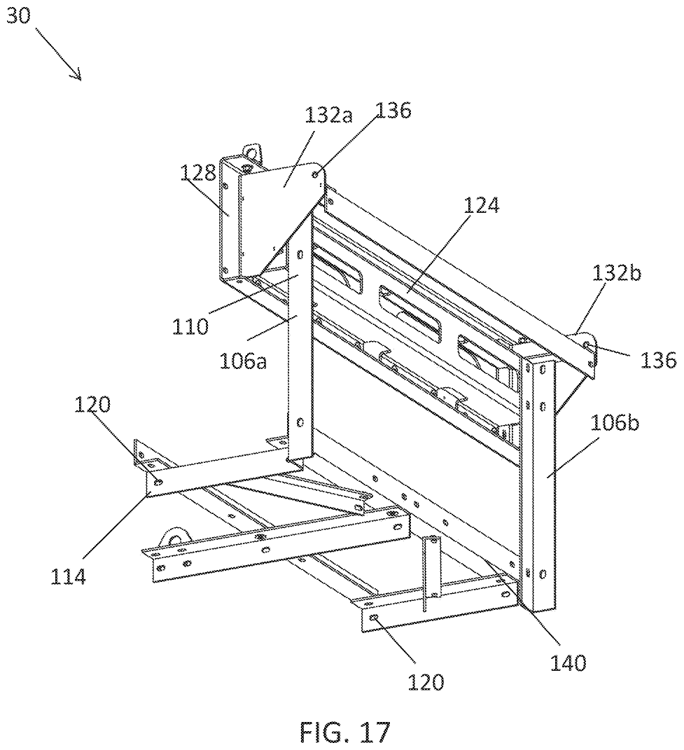

With reference to FIG. 16-17, the tiltable frame section 30 includes a first side frame section 106a and a second side frame section 106b. The first side frame section 106a is disposed at the first side of the frame 18 and the second side frame section 106b is disposed at the second side of the frame 18. The first and second side frame sections 106a, 106b each include a vertical beam section 110 extending in the height direction and a horizontal beam section 114 extending in a width direction. The vertical beam section 110 is perpendicular to the horizontal beam section 114. The vertical beam section 110 and the horizontal beam section 114 together define an L-shape. The vertical beam section 110 and the horizontal beam section 114 are coupled at a first end of the vertical beam section 110. The vertical beam sections 110 include connecting apertures 120 disposed proximate the first ends. The connecting apertures 120 are configured to selectively align with the tilt holes 94 on the tilt-locking brackets 66a, 66b to receive the fasteners 99, as described above.

The illustrated tiltable frame section 30 further includes a switchgear frame section 124. The switchgear frame section 124 is configured to support the switchgear 14. More specifically, the switchgear 14 may be coupled to the switchgear frame section 124 and supported by the switchgear frame section 124. The switchgear frame section 124 is coupled to second ends of the vertical beam sections 110. The switchgear frame section 124 includes a front frame section 128 and the first and second side brackets 132a, 132b. The front frame section 128 extends between the first side frame section 106a and the second side frame section 106b. The first side brackets 132a is disposed proximate an outside face of the first side frame section 106a. The second side bracket 132b is disposed proximate an outside face of the second side frame section 106b. Therefore, the first and second side frame sections 106a, 106b are disposed between the first and second side brackets 132a, 132b. The front frame section 128 is coupled to front faces of the vertical beam sections 110 of the first and second side frame sections 106a, 106b via fasteners. The tiltable frame section 30 further includes cross beams 140 for coupling the first side frame section 106a to the second side frame section 106b. The cross beams 140 are perpendicular to the first and second side frame sections 106a, 106b. The tiltable frame section 30 may additionally include cross beams 140 oriented in the width direction.

In use, the switchgear assembly 10 may advantageously be transported to a desired location (e.g., electrical vault, etc.) in a compact configuration, as shown in FIGS. 1 and 11, with the slidable frame section 26 in its lowered position and the tiltable frame section 30 in its untilted or vertical position. The switchgear assembly 10 may then be lifted in its entirety by the hoist (e.g., to unload the switchgear assembly from its transport vehicle) and placed in its desired installation location. Once in the desired installation location, the base frame section 22 may be secured to a surface, such as the floor of the electrical vault, a concrete pad, etc. With the base frame section 22 secured, the user may then couple the hoist to the slidable frame section 26 to raise the slidable frame section 26, and with it, the switchgear 14, relative to the base frame section 22. The hoist raises the slidable frame section 26 to a desired height where the apertures 82 in the base frame section 22 are aligned with the apertures 78 in the slidable frame section 26, as shown in FIG. 12. The user inserts then inserts fasteners through the apertures 82, 78 to lock the slidable frame section 26 in the desired position. The user may then disconnect the hoist from the slidable frame section 26 and connect the hoist to the tiltable frame section 30.

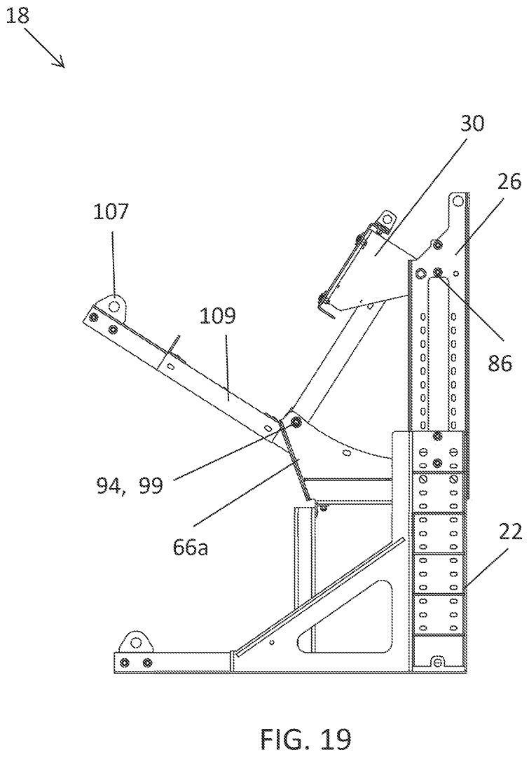

With reference to FIGS. 18-19, to tilt the tiltable frame section 30, the tiltable frame section 30 is coupled to the hoist. In the illustrated embodiment, the tiltable frame section 30 includes a lifting bracket 107 on an extended arm 109 configured for coupling to the hoist. The hoist provides a lifting force (e.g., on the lifting bracket 107) to pivot the tiltable frame section 30 about the pivot axis 90. The crane continues to pivot the tiltable frame section 30 until the connecting aperture 120 on the tiltable frame section 30 is aligned with the tilt hole 94 corresponding with a desired orientation of the tiltable frame section 30. Once the tiltable frame section 30 is at a desired tilt orientation, a fastener 99 is inserted through each connecting aperture 120 and the corresponding tilt hole 94. The fasteners 99 hold the tiltable frame section 30 at the desired tilt orientation. In other words, the fasteners 99 lock the tiltable frame section 30 at the desired tilt orientation. To alter the tilt orientation of the tiltable frame section 30, the hoist holds the tiltable frame section 30 in place. The fasteners 99 are then removed from each connecting aperture 120 and the corresponding tilt hole 94. The hoist may then be used to increase or decrease the tilt angle of the tiltable frame section 30. If the hoist is not holding the tiltable frame section 30 in place when the fasteners are removed, the backstop beam 102 stops the tiltable frame section 30 from swinging beyond the backstop beam 102. Specifically, a back face of the vertical beam sections 110 proximate the first ends of the vertical beam sections 110 engage with the backstop beam 102 when the vertical beam sections 110 are generally parallel with the C-shaped channels 50a, 50b, to define the vertical or untilted position of the tiltable frame section 30.

Since the frame 18 adjusts the height of the switchgear 14 and the tilt orientation of the switchgear 14, the switchgear 14 may be height adjusted and angled on site, during installation, without removing the switchgear 14 frame the frame assembly 18. Height adjusting and angling the switchgear 14 also facilitates allowing installers to couple cables to a front surface of the switchgear 14. Finally, the adjustability of the frame 18 permits the switchgear assembly 10 to be shipped in a compact configuration and then adjusted on site.

Although the disclosure has been described in detail with reference to certain preferred embodiments, variations and modifications exist within the scope and spirit of one or more independent aspects of the disclosure as described.

Various features and advantages of the disclosure are set forth in the following claims.

What is claimed is:

1. A switchgear assembly comprising:
a switchgear; and
a frame configured to support the switchgear, the frame including,
a base frame section connected to a base surface,
a slidable frame section slidably coupled to the base frame section and movable to vary a height of the switchgear relative to the base surface, and
a tiltable frame section pivotably coupled to the slidable frame section and movable to vary a tilt angle of the switchgear relative to the base surface.

2. The switchgear assembly of claim 1, wherein the switchgear is coupled to and supported by the tiltable frame section.

3. The switchgear assembly of claim 2, wherein the base frame section is movable to vary the height of the switchgear and the tiltable frame section is movable to vary the tilt angle of the switchgear while the switchgear is coupled to and supported by the tiltable frame section.

4. The switchgear assembly of claim 1, wherein the base frame section includes a C-shaped channel, and wherein the slidable frame section includes a C-shaped channel slidably received by the C-shaped channel of the base frame section.

5. The switchgear assembly of claim 1, wherein the slidable frame section includes a tilt-locking bracket, and wherein the tilt-locking bracket includes a plurality of tilt holes, each corresponding with a different tilt angle of the switchgear relative to the base surface.

6. The switchgear assembly of claim 5, further comprising a fastener insertable through a selected one of the plurality of tilt holes to prevent the tiltable frame section from pivoting.

7. The switchgear assembly of claim 5, wherein the tiltable frame section is pivotable about a pivot axis at least partially formed by the tiltable frame section and the slidable frame section, and wherein the tilt holes are spaced apart from one another at a constant radius from the pivot axis.

8. The switchgear assembly of claim 5, wherein the slidable frame section includes a backstop configured to prevent the tiltable frame section from pivoting beyond the backstop.

9. A frame for use with a switchgear, the frame comprising:
a base frame section connected to a base surface;
a slidable frame section slidably coupled to the base frame section and movable relative to the base frame section between a raised position and a lowered position; and
a tiltable frame section pivotally coupled to the slidable frame section and pivotable about a pivot axis relative to the slidable frame section between a vertical position and a tilted position,
wherein the tiltable frame section is configured to support the switchgear.

10. The frame of claim 9, wherein the base frame section includes first and second channels, and wherein the slidable frame section includes first and second channels slidably received by the first and second channels of the base frame section.

11. The frame of claim 10, wherein each of the first and second channels of the slidable frame section includes a slot.

12. The frame of claim 9, wherein the slidable frame section includes a first and second tilt-locking brackets, and wherein each of the first and second tilt-locking brackets includes a plurality of tilt holes, each corresponding with a different tilt angle of the tiltable frame section relative to the slidable frame section.

13. The frame of claim 12, wherein the tilt holes are spaced apart from one another at a constant radius from the pivot axis.

14. The frame of claim 9, wherein the slidable frame section includes a backstop configured to prevent the tiltable frame section from pivoting beyond the backstop.

15. The frame of claim 9, wherein the tiltable frame section includes a hoist bracket configured to connect to a hoist.

16. A method of adjusting a position of a switchgear supported by a frame assembly including a base frame section, a slidable frame section, and a tiltable frame section, the method comprising:
coupling the base frame section to a base surface;
sliding the slidable frame section relative to the base surface to adjust a height of the switchgear;
locking the slidable frame section to the base frame section;
pivoting the tiltable frame section relative to the slidable frame section about a pivot axis to adjust a tilt angle of the switchgear; and
locking the tiltable frame section to the slidable frame section.

17. The method of claim 16, wherein locking the tiltable frame section to the slidable frame section includes aligning an aperture in the tiltable frame section with one of a plurality of apertures in the slidable frame section, and, inserting a fastener through the aligned apertures.

18. The method of claim 16, wherein locking the slidable frame section to the base frame section includes aligning an aperture in the slidable frame section with one of a plurality of apertures in the base frame section, and, inserting a fastener through the aligned apertures.

19. The method of claim 16, wherein sliding the slidable frame section and pivoting the tiltable frame section are performed while the switchgear is supported by the frame assembly.

20. The method of claim 19, wherein the method further includes adjusting one or more fasteners of the frame prior to sliding the slidable frame section and pivoting the tiltable frame section.
